(19) United States
(12) Patent Application Publication
(10) Pub. No.: US 2003/0200791 A1
(43) Pub. Date: Oct. 30, 2003

(54) Apparatus for determining the moisture content of a subfloor

(76) Inventor: Kurt Kohler, Ettlingen (DE)

Correspondence Address: Klaus J. Bach, 4407 Twin Oaks Drive, Murrysville, PA, 15668, US

(21) Appl. No.: 10/412,959

(22) Filed: Apr. 11, 2003

(30) Foreign Application Priority Data
Apr. 30, 2002 (DE) 202 06 903.6

(51) Int. Cl. G01M 3/02

(52) U.S. Cl. 73/37

(57) ABSTRACT

In an apparatus for determining the moisture content of a sub-floor which forms the dielectric for a conduit of a measuring arrangement and wherein an electronic evaluation unit is connected to the conduit for receiving echoes of pulse signals supplied to the conduit, and also to a storage unit for storing calibration data for converting dielectric constant values as determined from the time delay of the received echo signal to moisture content values of a cement and/or a calcium sulfate sub-floor for the determination of the cement and the calcium sulfate floor moisture content, the same calibration data are available to the electronic evaluation unit for both, the cement sub-floor and the calcium sulfate sub-floor.

### BACKGROUND OF THE INVENTION

The invention resides in an apparatus for determining the moisture content of a sub-floor, wherein the sub-floor represents the dielectric of a measuring arrangement and the apparatus includes an electronic evaluation unit for determining the dielectric constant of the sub-floor with a storage device for storing calibration data by way of which a dielectric constant measured can be converted to a moisture content value.

Such an apparatus is known for example from EP 0 478 851 B1 and this apparatus is successfully marketed by the applicant. The sub-floor forms the dielectric of a measuring conduit into one end of which a pulse signal is fed by a signal generator. The pulse signal is reflected at the other end of the measuring conduit and the reflected signal is received by a receiver. By means of a measuring unit, the time passed between feeding the signal into the measuring conduit and the return of the reflected signal is measured. In this way, the dielectric constant of the sub-floor can be accurately determined. Since the dielectric constant of the sub-floor depends on the moisture content of the sub-floor, a dielectric constant determined herewith can be converted to a moisture content value using the stored calibration data.

In addition to the apparatus described above, many other apparatus by which the moisture content of a sub-floor can be determined via dielectric constant measurements are commercially available. Although the procedure for measuring the dielectric constant may be different in various apparatus, they all include a data storage device, in which calibration data related to the respective sub-floor are stored so that a measured dielectric constant can be converted into a corresponding moisture content.

The known apparatus are used in many applications but they are not used for determining the moisture content of a subsoil of cement or a sub-floor which includes calcium sulfate, that is they are not used for the determination of the moisture content of a cement or calcium-sulfate sub-floor. The reason herefor may be the fact that the determination of the moisture content of a sub-floor of cement or calcium sulfate has particular problems.

The determination of the moisture content of a cement sub-floor is particularly important since further treatment of a sub-floor consisting of concrete depends to a large extent on the moisture content of the cement sub-floor. It is pointed out that the moisture content of a cement sub-floor must not exceed a certain value when a floor covering is to be applied to the cement sub-floor. Only when the moisture content of a cement sub-floor has dropped to a certain value, that is, when the sub-floor has reached bedding maturity, a floor covering can be placed onto the cement sub-floor. However, the bedding maturity of a cement sub-floor is different from that of for example a calcium sulfate sub-floor. The bedding maturity of a cement sub-floor may be reached for example when the moisture content has dropped to 3% whereas for a calcium sulfate sub-floor the moisture content must be as low as 0.5%.

For determining the moisture content of a sub-floor preparation, various methods are known. The most accurate method known is the so-called gravimetric method. With this method, a sample is taken from the sub-floor, which sample is dried over a predetermined period. The moisture content of the sub-floor is then determined on the basis of the weight difference.

The use of gravimetric methods however is different for cement sub-floors and for calcium sulfate sub-floors. Cement sub-floor samples are dried, for example, at a temperature of 105° whereas calcium sulfate sub-floor samples are dried at a temperature of 40° C. For the use of the gravimetric method, it is therefore necessary to know the type of sub-floor. Problematic or almost impossible is the use of the gravimetric method if the sub-floor consists of a mixture of cement and calcium sulfate. Furthermore, the gravimetric method has the disadvantage that it can be performed only in a laboratory.

For determining the moisture content of a sub-floor furthermore the so-called calcium carbide method is known. With this method again a sample is taken from the sub-floor which is then placed into a container in which it is mixed with calcium carbide. Because of the chemical reaction, the pressure in the container increases. The pressure increase is greater the greater the moisture content of the sub-floor is. The moisture content of the sub-floor can therefore be determined on the basis of the pressure increase.

The results obtained with the calcium carbide method correspond about to those achieved with the gravimetric method. However, for a cement sub-floor, the results have an offset of about 1.2%. That is if, with the gravimetric method, a moisture content of 6% would be determined for a cement subfloor, with the use of the calcium carbide method a value of 4.8% would be obtained. Consequently, a cement sub-floor, which reaches layout maturity at a 3% value when determined by the gravimetric method must show a moisture content of 1.8% if measured by the calcium carbide method.

With calcium sulfate sub-floor moisture content values, this offset is not present. That is, the moisture content values of a calcium sulfate subfloor obtained by way of the calcium carbide method corresponds to the moisture content values as obtained by the gravimetric method. Consequently, a calcium sulfate sub-floor, which has reached bedding maturity at a moisture content of 0.5% as determined by the gravimetric method, also has reached bedding maturity at a moisture content of 0.5% as determined by way of the calcium carbide method.

Since, with cement sub-floors and calcium sulfate sub-floors, the moisture content for bedding maturity is different, it is also with the calcium carbide method very important to know what type of sub-floor is being treated. If the sub-floor comprises a mixture of cement and calcium sulfate sub-flooring, it is almost impossible to determine the bedding maturity on the basis of the calcium carbide method.

It is the object of the present invention to provide an apparatus for determining the moisture content of a subfloor of cement and/or calcium sulfate accurately in a simple manner.

### SUMMARY OF THE INVENTION

In an apparatus for determining the moisture content of a sub-floor which forms the dielectric for a conduit of a measuring arrangement and wherein an electronic evaluation unit is connected to the conduit for receiving echoes of pulse signals supplied to the conduit, and also to a storage unit for storing calibration data for converting dielectric constant values as determined from the time delay of the received echo signal to moisture content values of a cement and/or a calcium sulfate sub-floor for the determination of the cement and the calcium sulfate floor moisture content, the same calibration data are available to the electronic evaluation unit for both, the cement sub-floor and the calcium sulfate sub-floor.

Since for determining the moisture content of a cement sub-floor, the same calibration data are used as for the moisture content determination of a calcium sulfate sub-floor, it is no longer necessary to distinguish between a cement and a calcium sulfate sub-floor. It has surprisingly been found that the dependency of the dielectric constant on the moisture content is for a cement sub-floor about the same as the that of a calcium sulfate sub-floor, that is that the dielectric constant value over moisture content curves have essentially the same pattern for both types of sub-floors. Specifically, it has been found that the value of the dielectric constant of a cement sub-floor with a moisture content of 3% as determined by the gravimetric method has about the same dielectric constant as a calcium sulfate sub-floor with a moisture content of 0.5% as determined by the gravimetric method.

Consequently, advantageously, the same calibration data can be used for the moisture content determination of a cement sub-floor as can be used for a calcium sulfate sub-floor. On the basis of a certain measured dielectric constant, it can for example be determined that, if the sub-floor is a cement sub-floor, it has a moisture content of 3% or, if the sub-floor is a calcium sulfate sub-floor it has a moisture content of 0.5%.

Since the measured dielectric constants with respect to the desired evidence (bedding maturity) have the same values for a cement sub-floor and a for a calcium-sulfate sub-floor, it is no longer necessary to know whether the sub-floor being examined is a cement sub-floor or a calcium sulfate sub-floor. With the apparatus according to the invention cement as well as calcium sulfate sub-floors can be equally tested. Furthermore, also sub-floors comprising cement and calcium sulfate can be examined without the need for knowing the mixture ratio.

The invention will be described below in greater detail on the basis of the accompanying drawings.

### BRIEF DESCRIPTION OF THE DRAWINGS

FIG. 1 shows schematically the apparatus according to the invention, and

FIGS. 2a and 2b show diagrams, in which the moisture content of a cement sub-floor and of a calcium sulfate sub-floor as determined by the gravimetric method (FIG. 2a) in comparison with the moisture content of the same cement and, respectively, calcium sulfate sub-floor as determined by the method according to the invention.

### DESCRIPTION OF A PREFERRED EMBODIMENT

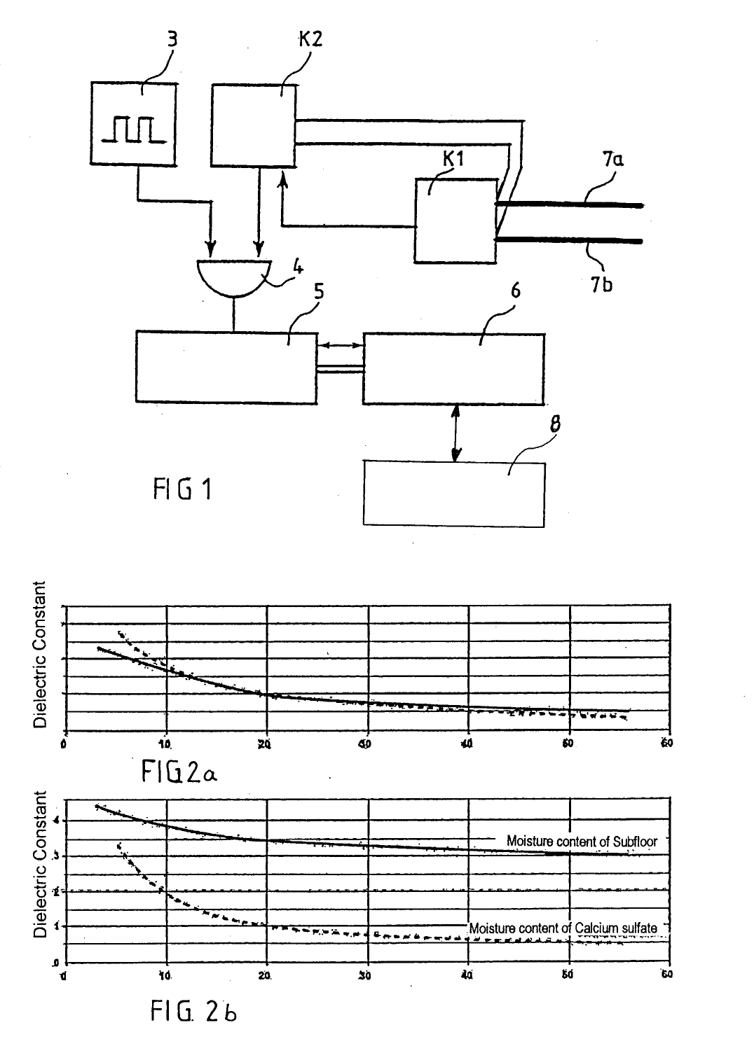

As shown in FIG. 1, the apparatus for determining the moisture content of a sub-floor includes an open measuring conduit, which consists of two parallel measuring rods 7a, 7b to which, at one end thereof, a voltage pulse with as steep as possible a voltage flank is applied. The voltage is generated by a signal source K1, which is connected to the measuring rods 7a and 7b by a connecting cable of negligible length. The internal resistance of the signal source K1 corresponds to the wave resistance of the open measuring conduit 7a, 7b as far as it is reproducible with simple means for the center area of the measuring range. In this way, at the jointure between the exit of the signal source K1 and the measuring conduit 7a, 7b, few interfering reflections are formed in the suitable measuring range. At the end of the open measuring conduit 7a, 7b, the voltage signal is fully reflected. The echo reaches the beginning of the conduit after a certain time which depends on the moisture content of the dielectric of the conduit 7a, 7b. By a threshold value switch k2, which compares the voltage at the electrical connection of the measuring rods 7a, 7b. By a threshold value switch K2, which compares the voltage at the electrical connection of the measuring rods 7a, 7b with predetermined values a gate signal for a counter 5 is generated, which counts, during the time from the beginning of the pulse signal introduction to the return of the echo, the pulses of an oscillator 3. The counter 5 is connected to an evaluation and indicating unit 6. The opening of the gate may be initiated by the signal source K1 in a delayed manner so that the gate is opened when the reflection at the connection of the measuring rods 7a, 7b is passed.

By a change of the material moisture content the dielectric constant and, consequently, the capacitance of the medium, which surrounds the rods of the measuring conduit 7a, 7b is changed. Since the geometric data of the measuring conduit 7a, 7b are constant, a correlation between the material moisture content and the measured travel time of the signal and the echo can be established which are stored in a storage device 8 as calibration data. The correlation can be stored in the form of an equation or as a calibration curve.

The storage device 8 may contain data for a first calibration stage which concerns for example stiff and dense sub-floors and data for a second calibration stage which concerns for example plastic and lower density sub-floors. As sub-floor, for example, a cement sub-floor, a calcium sulfate sub-floor or a mixed sub-floor may be used. Furthermore, the storage device 8 may contain data for further calibration stages concerning sub-floors, which cannot be examined with the calibration stages 1 and 2.

The data of the dielectric constant determined in the evaluation and indication unit 6 are supplied to the storage device 8 which, on the bases of the calibration data stored therein, converts them to cement moisture content, anhydrite moisture content and volumetric moisture content and returns them to the evaluation and indicating unit 6. The evaluation and indicating unit 6 can indicate cement moisture content and anhydrite moisture content at the same time. Concurrently, the volumetric moisture content can also be indicated.

As shown in FIG. 2a, the dielectric constant representing the moisture content, as determined by the apparatus according to the invention for a cement sub-floor (full line) is almost the same as that for a calcium sulfate sub-floor with a lower moisture content over time.

For example, after 50 days the dielectric constant of the cement sub-floor and of the calcium sulfate sub-floor are both about the same while their moisture contents are 3% and 0.5% respectively, this being the bedding maturities for the respective sub-floors.

The moisture content of the cement sub-floor as determined by the gravimetric method (full line in FIG. 2b) reaches bedding maturity of 3% after about fifty days, and the calcium sulfate sub-floor (dashed line) reaches bedding maturity (0.5% moisture content) also after about fifty days. For the determination of the moisture content by way of the apparatus according to the invention, it is therefore unimportant whether the sub-floor is a cement sub-floor or a calcium sulfate sub-floor.

What is claimed is:

1. An apparatus for determining the moisture content or bedding maturity of a sub-floor comprising cement or calcium sulfate, wherein the sub-floor forms the dielectric of a measuring arrangement, comprising: an electronic evaluation unit for determining the dielectric constant of said sub-floor, and a storage unit for storing calibration data, by way of which the dielectric constants determined are converted to a moisture content value, said storage unit using for the determination of the calcium sulfate sub-floor the same calibration data as for the cement sub-floor.
